(19) United States
(12) Patent Application Publication
(10) Pub. No.: US 2006/0137720 A1
(43) Pub. Date: Jun. 29, 2006

(54) Method for the removal of organic residues from finely structured surfaces

(75) Inventors: Michael Oehler, Sassenberg (DE); Rainer Kosters, Horstel-Bevergern (DE)

Correspondence Address: RICHARD M. GOLDBERG, 25 EAST SALEM STREET, SUITE 419, HACKENSACK, NJ, 07601, US

(73) Assignee: Technotrans AG, Sassenberg (DE)

(21) Appl. No.: 10/536,000

(22) PCT Filed: Nov. 24, 2003
(86) PCT No.: PCT/EP03/13193

§ 371 Date: Dec. 13, 2005

(30) Foreign Application Priority Data
Nov. 26, 2002 (DE) 102 54 990.7

(51) Int. Cl. B08B 7/00; B08B 3/00

(52) U.S. Cl. 134/26; 134/34; 134/19

(57) ABSTRACT

Method for removing of organic residues from finely structured surfaces, in which the residues are incinerated by ozone.

The invention relates to a method for removing of organic residues from finely structured surfaces.

As an example, reference shall be made to the removing of photo resist lacquer residues from metallic injection moulding matrices for Manufacturing of CD or DVD discs, but the Invention shall not be limited to this method.

When manufacturing CD's or DVD's, first a photo resist lacquer layer is applied onto a glass pane. This lacquer layer is dried. It is afterwards exposed in accordance with the digitally displayed sound pattern and washed out in the areas determined by the exposure. Then a thin electrically conductive layer of metal, e.g. nickel, is applied by evaporating in an electric field onto the lacquer layer, and afterwards a 300 μm thick metal layer is applied onto the thin metal layer, particularly nickel layer, as a starting layer by a galvanic method.

The metal layer produced by this method is used during the further proceedings as injection moulding mould for manufacturing of CD's and DVD's. For this purpose the metal layer must be peeled from the photo resist lacquer layer. In this connection, substantial parts of the lacquer layer remain on the metal plate. It is rather easy to remove the residues to a great deal by a suitable pre-cleaning step. In the boarder layer between metal and photo resist lacquer however, there is formed a strongly cross linked photo resist lacquer by the method which is difficult to remove in the finely structured surface of the metal plate.

A removal of these residues by means of solvents is known in the art but only leads to non-satisfactory results. More effective but also substantially more complicated is cleaning by means of plasma burners or excimer lasers.

These methods have the disadvantage that they require high investment and operational costs and that they can be used only in a very narrow field if it is to be reliably prevented that the basic substrate, In the present example the metal plate is damaged.

It is the object of the invention to provide a method by which it is possible to incinerate the organic residues remaining on or in a finely structured surface with a low demand of investment and operational costs.

To comply with this object, the above method according to the invention is characterized in that the residues are incinerated by means of ozone.

It turned out surprisingly that the strongly oxidizing effect of the ozone is sufficient to remove organic residues from the finely structured surface without damaging the surface structure.

The ozone may be blown onto the surface to be cleaned by means of at least one nozzle. One or a plurality of nozzles may be guided along predetermined pathes over the surface, or the surface may be moved along one or a plurality of nozzles. It is also possible to put the parts to be cleaned into an ozone chamber wherein ozone in a predetermined concentration exists,

The ash components may be removed by suction, blowing or washing by means of a suitable rinsing device without difficulties.

The ozone may be provided by a relatively simple ozone generator in place which Is causing an electrostatic discharge. By means of an ozone generator of this kind it is possible to provide a great volume of ozone at low costs. This allows short treating times.

Methods using the ozone production by means of UV-light are obviously less favourable. In this case the ozone output is comparatively small, and the resulting heat is not favourable for the result to be obtained.

What is claimed is:

1. Method for removing of organic residues from finely structured surfaces, comprising the step of incinerating the residues ozone.

2. Method as claimed in claim 1, further comprising the step of blowing the ozone onto the surface to be cleaned by at least one nozzle.

3. Method as claimed in claim 2, further comprising the step of moving the at least one nozzle over the surface to be cleaned in predetermined paths.

4. Method as claimed in claim 2, further comprising the step of passing the surface to be cleaned along the at least one nozzle.

5-8. (canceled)

9. Method as claimed in claim 1, further comprising the step of sucking the incinerated residues from the surface.

10. Method as claimed in claim 1, further comprising the step of blowing the incinerated residues from the surface.

11. Method as claimed in claim 1, further comprising the step of rinsing out the incinerated residues by a cleaning solution.

12. Method as claimed in claim 1, further comprising the step of producing the ozone during the cleaning process by an ozone generator.
